(19) United States
(12) Patent Application Publication
(10) Pub. No.: US 2021/0253083 A1
(43) Pub. Date: Aug. 19, 2021

(54) Method and System for Evaluating an Operating Condition of a Motor Vehicle

(71) Applicant: ZF Friedrichshafen AG, Friedrichshafen (DE)

(72) Inventors: Juri Pawlakowitsch, Kressbronn (DE); Martin Grumbach, Hoerbranz (AT)

(21) Appl. No.: 17/178,839

(22) Filed: Feb. 18, 2021

(30) Foreign Application Priority Data
Feb. 19, 2020 (DE) 10 2020 202 128.7

(51) Int. Cl. B60W 20/16; B60W 10/04; H02J 3/32; G07C 5/08; G07C 5/00

(52) U.S. Cl. CPC B60W 20/16; B60W 10/04; B60W 2756/10; G07C 5/0841; G07C 5/008; H02J 3/322

(57) ABSTRACT

A method for evaluating an operating condition of a motor vehicle, which includes an electrical-mechanical energy converter and a chemical-mechanical energy converter, is provided. The method includes detecting an operating condition of the chemical-mechanical energy converter of the motor vehicle, transmitting the detected operating condition of the chemical-mechanical energy converter to a location remote from the motor vehicle, and evaluating the detected operating condition of the chemical-mechanical energy converter at the location remote from the motor vehicle by comparing the operating condition of the chemical-mechanical energy converter with a reference value of the operating condition of the chemical-mechanical energy converter in order to determine emissions of a motor vehicle fleet including at least two motor vehicles.

### CROSS-REFERENCE TO RELATED APPLICATION

The present application is related and has right of priority to German Patent Application No. 102020202128.7 filed on Feb. 19, 2020, which is incorporated by reference in its entirety for all purposes.

### FIELD OF THE INVENTION

The present application relates generally to a method and a system for evaluating an operating condition of a motor vehicle.

### BACKGROUND

Methods and systems for evaluating an operating condition of a motor vehicle are known, in principle.

### SUMMARY OF THE INVENTION

Example aspects of the present application provide an improved method and an improved system for evaluating an operating condition of a motor vehicle, wherein the motor vehicle includes an electrical-mechanical energy converter and a chemical-mechanical energy converter.

The method includes the detecting an operating condition of the chemical-mechanical energy converter of the motor vehicle, transmitting the detected operating condition of the chemical-mechanical energy converter to a location remote from the motor vehicle, and evaluating the detected operating condition of the chemical-mechanical energy converter at the location remote from the motor vehicle by comparing the operating condition of the chemical-mechanical energy converter with a reference value of the operating condition of the chemical-mechanical energy converter.

The motor vehicle includes a chemical-mechanical energy converter as well as an electrical-mechanical energy converter. A chemical-mechanical energy converter is an energy converter, which is designed for converting the energy contained in a chemical source or in a chemical carrier, for example, into a mechanical rotational energy. A chemical energy source is typically a fossil-fuel energy source, such as, for example, a fuel based on crude petroleum, such as, for example, gasoline or diesel, or based on natural gas. In this case, the chemical-mechanical energy converter is a conventional internal combustion engine.

The chemical-mechanical energy converter is utilized for supplying the rotational energy to a generator, in order to obtain electrical energy. Optionally, the chemical-mechanical energy converter can directly drive one or multiple axles of the motor vehicle. The generated electrical energy is then utilized for charging an electric accumulator of the motor vehicle, such as a battery or an accumulator, or for storing energy therein. If the chemical-mechanical energy converter is utilized exclusively for charging the electric accumulator and not for directly driving the motor vehicle, the chemical-mechanical energy converter is also referred to as a range extender, or REX.

The electrical-mechanical energy converter is designed for converting the energy contained in the electric accumulator into a mechanical rotational energy. The electrical-mechanical energy converter is typically an electric motor or an electric machine, which generates a rotational energy from electrical energy from the electric accumulator and, as a result, drives one or multiple axles of the motor vehicle.

The motor vehicle including the electrical-mechanical energy converter and the chemical-mechanical energy converter can also be referred to as a hybrid vehicle.

In particular, the motor vehicle can be a plug-in hybrid vehicle (PHEV). For this purpose, the motor vehicle includes a plug socket, with which the electric accumulator, in addition to the chemical-mechanical energy converter, can be charged, for example, by an external power supply, such as a charging station or by a cable in a garage or at a parking space.

In addition, the motor vehicle can, additionally or alternatively, include one or multiple energy recuperation devices, which are also referred to as recuperation devices. With these devices, a potential energy previously gained by acceleration can be recuperated, for example, during braking or already during a non-acceleration of the motor vehicle, for example, via one or multiple generators at the wheels or axles of the motor vehicle. This energy can then also be utilized by supplying the energy to the electric accumulator, i.e., for charging the electric accumulator.

The method initially includes detecting an operating condition of the chemical-mechanical energy converter of the motor vehicle.

An operating condition of the chemical-mechanical energy converter is, in the simplest case, either “on” or “off”. In the “on” operating condition, the energy converter is operated, i.e., the energy converter consumes energy or converts the energy. In the “off” operating condition, the energy converter is not operated. Therefore, the energy converter is idle and/or consumes or converts no energy. For the case in which the chemical-mechanical energy converter is an internal combustion engine, the “on” operating condition means that the engine is running, and the “off” operating condition means that the engine is not running.

The operating condition can be detected in highly diverse ways, either individually or in combination. For example, the operating condition can be detected via the presence of an ignition spark or via a rotational speed sensor or torque sensor of the chemical-mechanical energy converter. In addition, the operating condition can be detected via the read-out of a control unit of the chemical-mechanical energy converter. The operating condition can also be detected, for example, via a voltage or current present at a generator connected to the chemical-mechanical energy converter.

The detection of an operating condition of the chemical-mechanical energy converter can also include, in a broader sense, the detection of an operating point of the chemical-mechanical energy converter. An operating point means, in the present case, a point or an intercept along a characteristic curve of the chemical-mechanical energy converter, which is usually plotted in a coordinate system made up of rotational speed and torque. For a chemical-mechanical energy converter, there exist(s) one or multiple points along the characteristic curve, at which the chemical-mechanical energy converter can be operated in a better or more optimal manner, because an advantageous power yield or economy of the chemical-mechanical energy converter results.

The detection of the operating point of the chemical-mechanical energy converter can additionally include, for this purpose, detecting whether the chemical-mechanical energy converter is operated at one of these optimal operating points or at which of several possible operating points the chemical-mechanical energy converter is operated. This takes place, for example, by detecting a rotational speed and a torque of the chemical-mechanical energy converter by one or multiple sensor(s). In addition, the operating point or the presence of a certain operating point can be detected via the read-out of a control unit of the chemical-mechanical energy converter.

The detected operating condition can be stored, for this purpose, in a memory in the motor vehicle.

In addition, the method includes transmitting the detected operating condition of the chemical-mechanical energy converter to a location remote from the motor vehicle.

The location remote from the motor vehicle is typically one or multiple server(s), which is/are situated, for example, in a central data center and, there, receive(s) messages from multiple motor vehicles and evaluate(s) the messages. For example, the server(s) at the remote location is/are administered by an authority or a government agency, which monitors emissions in inner-city areas. Alternatively or additionally, a vehicle owner or fleet operator controls the server(s) at the remote location or has access thereto.

The transmission can take place via a transmitting device installed in the motor vehicle, which can read out the operating condition from the memory. For this purpose, a message is transmitted via a wireless radio system. For example, the message can be a Car2X communication, for example, a Car2Infrastructure communication. The wireless radio system can be, for example, a mobile radio system, for example, 2G, 3G, 4G, etc. Alternatively or additionally, the message can also be transmitted via Bluetooth, WLAN, or another wireless communication standard.

The message can include the detected operating condition and further information, such as, for example, the motor vehicle type and/or the type of the chemical-mechanical energy converter. The message can also include further information, such as a position of the motor vehicle and/or an acceleration condition of the motor vehicle. In addition, the message can contain information that can be read out of a control unit of the motor vehicle.

The message can be transmitted, in particular, periodically, regularly, or when changes are made. For example, the message can be transmitted once every five (5), ten (10), sixty (60), or one hundred and twenty 120 seconds. Alternatively or additionally, the message can be transmitted in an event-driven manner, i.e., when there is a change in the operating condition, in particular at every switch-on and/or switch-off and/or when an operating point has been reached and/or exited, when there is a change in the position, in particular when a certain or particular position or an area has been reached and/or exited and/or when a certain acceleration or speed has been reached and/or exited, in particular when a standstill has been reached and/or exited, etc.

The method also includes evaluating the operating condition of the chemical-mechanical energy converter at the location remote from the motor vehicle by comparing the detected operating condition of the chemical-mechanical energy converter with a reference value of the operating condition of the chemical-mechanical energy converter in order to determine emissions of a motor vehicle fleet including at least two motor vehicles.

The evaluation takes place via one or multiple processing unit(s), which are contained, for example, on a server at the remote location. For example, various reference values are stored at the remote location. For example, various reference values can be stored for various vehicle types and, in particular, various variants of chemical-mechanical energy converters. These reference values can originate, for example, from evaluations on the test stand or during the development of the motor vehicle.

Optionally, if the comparison of the detected operating condition of the chemical-mechanical energy converter with a reference value of the operating condition of the chemical-mechanical energy converter yields a deviation that is greater than a predetermined threshold value, a suitable measure can be implemented at the remote location.

The method has the advantage that the operating condition of at least two motor vehicles during the real operation can be detected and evaluated at one central location. Therefore, it is possible to detect an undesirable, in particular excessive, operation of the chemical-mechanical energy converter instead of or in addition to the electrical-mechanical energy converter of the motor vehicle for an entire vehicle fleet.

Suitable agencies, such as, for example, an authority, can charge a fee or a tax based thereon. The method can be utilized, in particular, on more than two motor vehicles, in particular on all vehicles of a manufacturer or of a fleet operator, and the vehicles can then be evaluated individually.

In addition, the compliance with emission regulations can be detected or checked particularly well by the method.

The method can be refined in that the operating condition of the chemical-mechanical energy converter includes a fuel consumption of the chemical-mechanical energy converter.

The fuel consumption can be an instantaneous value or an average value across a certain, in particular predetermined, time period. For example, the operating condition can be a value in liters per one hundred kilometers (l/100 km) or kilometers per liter (km/l), which is optionally detected across a time period of one day, one week, or one month. For this purpose, the fuel consumption can be read out of a control unit or detected in the real operation, for example, by a flow gauge in a fuel line of the chemical-mechanical energy converter.

This detected value of the fuel consumption is then compared with a reference value of the fuel consumption at the remote location.

Due to this refinement, it is possible to particularly accurately detect and tax the fuel consumption for one or multiple motor vehicle(s). In addition, it is possible, due to this refinement, to detect a defect of the chemical-mechanical energy converter.

The method can be refined in that the operating condition of the chemical-mechanical energy converter includes a CO2 production of the chemical-mechanical energy converter.

The CO2 production can be an instantaneous value or an average value across a certain, in particular predetermined, time period. For example, the CO2 production can be a value in g/km, which is optionally detected across a time period of one day, one week, or one month. For this purpose, the CO2 production can be calculated based on fuel consumption or detected in the real operation, for example, by a sensor in the exhaust gas train of the motor vehicle.

This detected value of the CO2 production is then compared with a reference value of the CO2 production at the remote location.

Due to this refinement, it is possible to particularly accurately detect and tax the CO2 production for one or multiple motor vehicle(s). In addition, it is also possible, due to this refinement, to detect a defect of the chemical-mechanical energy converter.

The method can be refined in that the method additionally includes detecting an operating condition of the electrical-mechanical energy converter of the motor vehicle, wherein transmitting additionally includes transmitting the operating condition of the electrical-mechanical energy converter, and wherein evaluating additionally includes evaluating the operating condition of the electrical-mechanical energy converter at the location remote from the motor vehicle by comparing the detected operating condition of the electrical-mechanical energy converter with a reference value of the operating condition of the electrical-mechanical energy converter.

An operating condition of the electrical-mechanical energy converter is, in the simplest case, either “on” or “off”, similarly to the operating condition of the chemical-mechanical energy converter. In the “on” operating condition, the energy converter is operated, i.e., the energy converter consumes energy or converts energy. In the “off” operating condition, the energy converter is not operated. Therefore, the energy converter is idle and/or consumes or converts no energy.

The operating condition can be detected in highly diverse ways, either individually or in combination. For example, the operating condition can be detected via a rotational speed sensor or torque sensor of the electrical-mechanical energy converter. In addition, the operating condition can be detected via the read-out of a control unit of the electrical-mechanical energy converter. The operating condition can also be detected, for example, via a voltage or current tapped or present at the electrical-mechanical energy converter.

The detection of an operating condition of the electrical-mechanical energy converter can also include, in a broader sense, the detection of an operating point of the electrical-mechanical energy converter. An operating point means, in the present case, a point or an intercept along a characteristic curve of the electrical-mechanical energy converter, which is usually plotted in a coordinate system made up of rotational speed and torque. For an electrical-mechanical energy converter, there exist(s) one or multiple points along the characteristic curve, at which the electrical-mechanical energy converter can be operated in a better or more optimal manner, because an advantageous power yield or economy of the electrical-mechanical energy converter results.

The detection of the operating point of the electrical-mechanical energy converter can additionally include, for this purpose, detecting whether the electrical-mechanical energy converter is operated at one of these optimal operating points or at which of several possible operating points the electrical-mechanical energy converter is operated. This takes place, for example, by detecting a rotational speed and a torque of the electrical-mechanical energy converter by one or multiple sensor(s). In addition, the operating point or the presence of a certain operating point can be detected via the read-out of a control unit of the electrical-mechanical energy converter.

Due to this refinement, it is possible to create accurate operating profiles for a vehicle or an entire fleet. In particular, it is possible, in this way, to detect when and for how long an electrical-mechanical energy converter is operated in relation to a chemical-mechanical energy converter.

The method can be refined in that the operating condition of the electrical-mechanical energy converter includes an energy consumption of the electrical-mechanical energy converter.

The energy consumption can take place, for example, via a voltage and/or current tapped by the electrical-mechanical energy converter. Alternatively or additionally, the energy consumption can be detected at an electric accumulator, which supplies the electrical-mechanical energy converter.

Due to this refinement, it is possible to particularly accurately detect and tax the electrical energy consumption for one or multiple motor vehicle(s). In particular, it is also particularly accurately possible, in this way, to set and detect the energy consumption of the electrical-mechanical energy converter in relation to the fuel consumption and/or to a CO2 production of the chemical-mechanical energy converter. In addition, it is also possible, due to this refinement, to detect a defect of the electrical-mechanical energy converter.

The method can be refined, in that, when the comparison of the detected operating condition of the chemical-mechanical energy converter with a reference value of the operating condition of the chemical-mechanical energy converter yields a deviation that is greater than a predetermined threshold value, the method includes transmitting a request to change the operating condition of the chemical-mechanical energy converter to the motor vehicle from the remote location and of carrying out the change of the operating condition of the chemical-mechanical energy converter in the motor vehicle.

For example, the exceedance of a reference value can be the excessively frequent switch-on of the chemical-mechanical energy converter. For example, a reference value is stored, that corresponds to five activations in a certain time period. If the chemical-mechanical energy converter is now switched on or operated a sixth time in the certain time period, the threshold value is exceeded and a request to change the operating condition of the chemical-mechanical energy converter is transmitted from the remote location to the motor vehicle.

Alternatively or additionally, the threshold value is a relative value, for example, an exceedance in percentage (%) of a predetermined reference value. If, for example, the reference value relates to a fuel consumption, the threshold value can be, for example, ten percent (10%) above the reference value. For example, a fuel consumption of five liters per one hundred kilometers (5 l/100 km) can be specified and, thereby, an exceedance of a fuel consumption of five and a half liters per one hundred kilometers (5.5 l/100 km) can prompt the transmission of a request to change the operating condition.

The transmission from the remote location to the motor vehicle can take place via the same or another communication channel than the transmission to the remote location from the motor vehicle.

The request to change the operating condition can include, for example, switching off the chemical-mechanical energy converter or shifting the operating point to a more optimal operating point, for example, toward a higher or lower rotational speed of the chemical-mechanical energy converter. This operating condition change is then carried out at the chemical-mechanical energy converter, for example, by a control unit.

This refinement has the advantage that, in this way, the compliance with emission regulations can be implemented particularly well.

The method can be refined, in that the method additionally includes transmitting a request to change the operating condition of the electrical-mechanical energy converter to the motor vehicle from the remote location and carrying out the operating condition change of the electrical-mechanical energy converter in the motor vehicle.

A request to change the operating condition or carrying out the change in the operating condition can include, for example, switching on the electrical-mechanical energy converter, in particular during a simultaneous switch-off of the chemical-mechanical energy converter, and/or shifting an operating point of the electrical-mechanical energy converter. The operating condition change can also be carried out by a control unit.

This refinement has the advantage that, in this way, the compliance with emission regulations can be implemented particularly well.

The method can be refined, in that, when the comparison of the detected operating condition of the electrical-mechanical energy converter with a reference value of the operating condition of the electrical-mechanical energy converter yields a deviation that is greater than a predetermined threshold value, the method includes transmitting a request to change the operating condition of the electrical-mechanical energy converter to the motor vehicle from the remote location and carrying out the change of the operating condition of the electrical-mechanical energy converter in the motor vehicle.

For example, the exceedance of a reference value can be the insufficiently frequent switch-on of the electrical-mechanical energy converter. For example, a reference value is stored, that corresponds to five activations in a certain time period. If the chemical-mechanical energy converter is now switched on or operated only four times in the certain time period, the threshold value is exceeded and a request to change the operating condition of the electrical-mechanical energy converter is transmitted from the remote location to the motor vehicle.

Alternatively or additionally, the threshold value is a relative value, for example, an exceedance in percentage (%) of a predetermined reference value. If, for example, the reference value relates to an energy consumption, the threshold value can be, for example, ten percent (10%) above the reference value. For example, a fuel consumption of fifteen kilowatt-hours per one hundred kilometers (15 kWh/100 km) can be specified and, thereby, an exceedance of an energy consumption of sixteen and a half kilowatt-hours per one hundred kilometers (16.5 kWh/100 km) can prompt the transmission of a request to change the operating condition.

The request to change the operating condition can include, for example, switching the electrical-mechanical energy converter on or off, or shifting the operating point to a more optimal operating point, for example, toward a higher or lower rotational speed of the electrical-mechanical energy converter. This operating condition change is then carried out at the electrical-mechanical energy converter, for example, by a control unit.

This refinement has the advantage that, in this way, the compliance with emission regulations can be implemented particularly well.

The method can be refined, in that the method additionally includes transmitting a request to change the operating condition of the chemical-mechanical energy converter to the motor vehicle from the remote location and carrying out the operating condition change of the chemical-mechanical energy converter in the motor vehicle.

In particular, if the electrical-mechanical energy converter has an unnaturally high energy consumption, a defect can be inferred and the electrical-mechanical energy converter can be switched off, accompanied by a switch-on of the chemical-mechanical energy converter.

This refinement has the advantage that it is particularly safe.

The method can be carried out by one or multiple suitable device(s). In particular, the method can be carried out partially or completely by one or multiple computer(s).

As mentioned at the outset, example aspects of the present application also provide a system for evaluating an operating condition of a motor vehicle, wherein the motor vehicle includes an electrical-mechanical energy converter and a chemical-mechanical energy converter, and wherein the system is configured for carrying out one of the aforementioned embodiments of the method.

### BRIEF DESCRIPTION OF THE DRAWINGS

Embodiments of the system and of the method are now described by way of example with reference to the attached figures, in which

FIG. 1 shows a diagrammatic view of one example embodiment of a system for evaluating an operating condition of a motor vehicle; and

FIG. 2 shows a diagrammatic sequence of at least one example embodiment of a method for evaluating an operating condition of a motor vehicle.

Identical reference characters designate identical or similar features.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

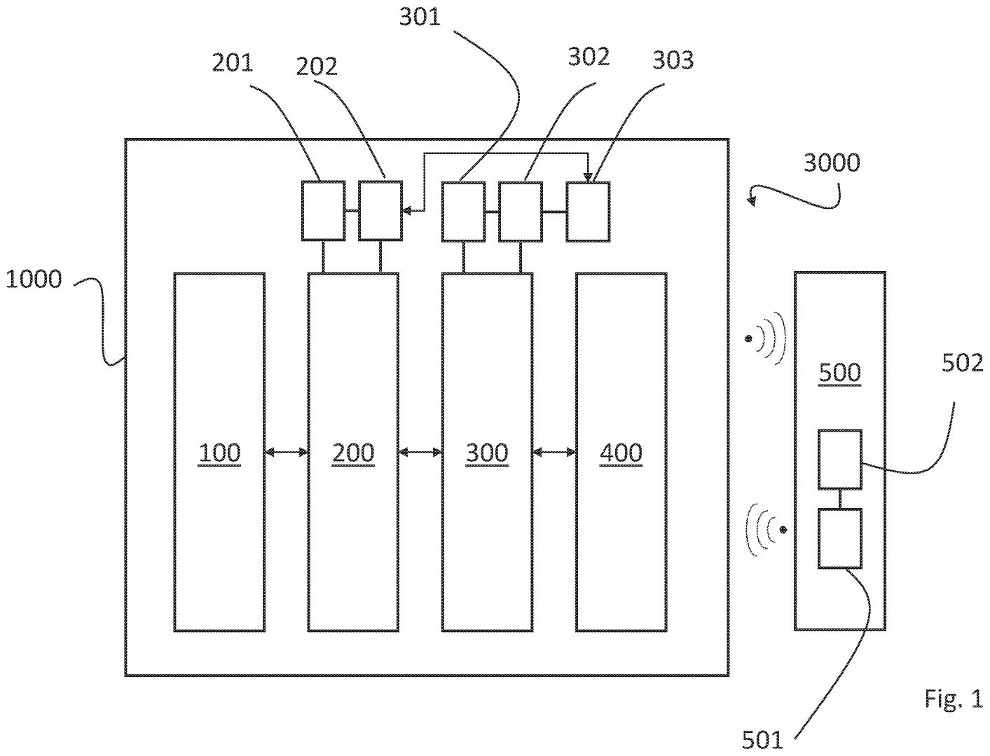

FIG. 1 shows a system 3000 for evaluating an operating condition of a motor vehicle 1000. The motor vehicle 1000 includes an electric accumulator 100, an electrical-mechanical energy converter 200, and a chemical-mechanical energy converter 300. In addition, the motor vehicle includes a transmitting device 400. The system 3000 also includes a location 500 remote from the motor vehicle 1000.

The system 3000 includes example means for carrying out detection of an operating condition of the chemical-mechanical energy converter 300 of the motor vehicle 1000, transmitting the detected operating condition of the chemical-mechanical energy converter 300 to a location 500 remote from the motor vehicle 1000, and evaluating the operating condition of the chemical-mechanical energy converter 300 at the location 500 remote from the motor vehicle 1000 by comparing the detected operating condition of the chemical-mechanical energy converter 300 with a reference value of the operating condition of the chemical-mechanical energy converter 300 in order to determine emissions of a motor vehicle fleet including at least two motor vehicles 1000.

A sensor 301 and a control unit 302 are associated with the chemical-mechanical energy converter 300. The sensor 301 is configured for detecting an operating condition of the chemical-mechanical energy converter 300 and is designed, for example, as a speed sensor. The control unit 302 is configured for the open-loop control and monitoring of the chemical-mechanical energy converter 300 and has a communication link to a transceiver 303. The transceiver 303 is designed, for example, as a mobile communications device.

A sensor 201 and a control unit 202 are associated with the electrical-mechanical energy converter 200. The sensor 201 is configured for detecting an operating condition of the electrical-mechanical energy converter 200 and is designed, for example, as a speed sensor. The control unit 202 is configured for the open-loop control and monitoring of the electrical-mechanical energy converter 200 and has a communication link to a transceiver 303.

A transceiver 501, which is designed, for example, as a mobile communications device, is provided at the remote location 500. The transceiver 501 is configured for receiving the signal of the transceiver 303. The transceiver 501 has a communication link to a processing unit 502. The processing unit 502 is designed, for example, as a computer.

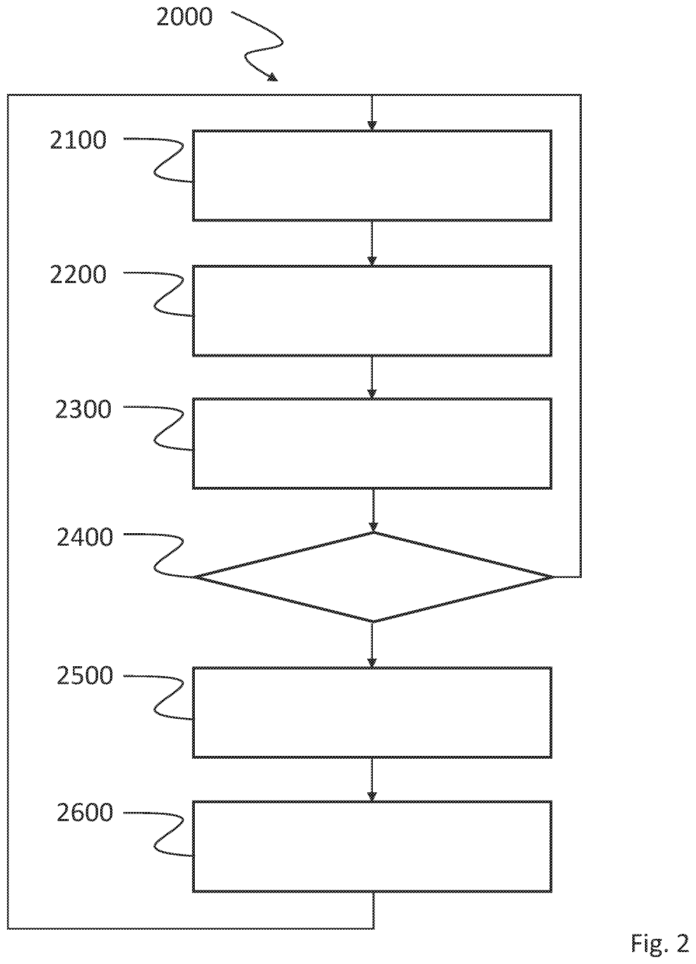

The details of the method carried out by the system 3000 are now explained in greater detail with reference to FIG. 2.

FIG. 2 shows a diagrammatic sequence of at least one example embodiment of a method 2000 for evaluating an operating condition of a motor vehicle. The motor vehicle includes an electrical-mechanical energy converter and a chemical-mechanical energy converter.

The method 2000 begins with (2100), in which an operating condition of the chemical-mechanical energy converter of the motor vehicle is detected. Optionally, an operating condition of the electrical-mechanical energy converter can also be detected simultaneously therewith or before or after detecting the operating condition of the chemical-mechanical energy converter.

Next in (2200), the detected operating condition of the chemical-mechanical energy converter and, optionally, also the detected operating condition of the electrical-mechanical energy converter is/are transmitted to a location remote from the motor vehicle.

In (2300), the detected operating condition of the chemical-mechanical energy converter and, optionally, also the detected operating condition of the electrical-mechanical energy converter is/are evaluated at the remote location. This evaluation takes place by comparing the detected operating condition of the chemical-mechanical energy converter with a reference value of the operating condition of the chemical-mechanical energy converter and, optionally, by comparing the detected operating condition of the electrical-mechanical energy converter with a reference value of the operating condition of the electrical-mechanical energy converter.

The following are optional. In (2400), it is decided whether the comparison of the detected operating condition of the chemical-mechanical energy converter with a reference value of the operating condition of the chemical-mechanical energy converter yields a deviation that is greater than a predetermined threshold value and, thereby, determining emissions of a motor vehicle fleet including at least two motor vehicles.

Optionally, it is also decided whether the comparison of the detected operating condition of the electrical-mechanical energy converter with a reference value of the operating condition of the electrical-mechanical energy converter yields a deviation that is greater than a predetermined threshold value. If not, the method 2000 ends and/or begins again with (2100).

If yes, the method continues with (2500). In (2500), a request to change the operating condition of the chemical-mechanical energy converter is transmitted to the motor vehicle from the remote location. Optionally, a request to change the operating condition of the electrical-mechanical energy converter can also be transmitted to the motor vehicle from the remote location.

In (2600), the requested operating condition change of the chemical-mechanical energy converter is then carried out in the motor vehicle. Optionally, the requested operating condition change of the electrical-mechanical energy converter can also be carried out in the motor vehicle.

After the completion of (2600), the method 2000 can start over with (2100).

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

100 electric accumulator
200 electrical-mechanical energy converter
300 chemical-mechanical energy converter
400 transmitting device
500 server
1000 motor vehicle
2000 method
2100 method step
2200 method step
2300 method step
2400 decision
2500 method step
2600 method step
3000 system for evaluation an operating condition of a motor vehicle

1-11. (canceled)

12. A method (2000) for evaluating an operating condition of a motor vehicle (1000) that includes an electrical-mechanical energy converter (200) and a chemical-mechanical energy converter (300), the method comprising:
detecting (2100) an operating condition of the chemical-mechanical energy converter (300) of the motor vehicle (1000) with a sensor (301), by reading out a control unit (302), or both;
transmitting (2200) the detected operating condition of the chemical-mechanical energy converter (300) to a location (500) remote from the motor vehicle (1000) with a transmitting device (303); and
evaluating (2300) the operating condition of the chemical-mechanical energy converter (300) at the location (500) remote from the motor vehicle (1000) by comparing the detected operating condition of the chemical-mechanical energy converter (300) with a reference value of the operating condition of the chemical-mechanical energy converter (300) with at least one processing unit (502) in order to determine emissions of a motor vehicle fleet including at least two motor vehicles (1000).

13. The method (2000) of claim 12, wherein the operating condition of the chemical-mechanical energy converter (300) comprises a fuel consumption of the chemical-mechanical energy converter (300).

14. The method (2000) of claim 12, wherein the operating condition of the chemical-mechanical energy converter (300) comprises a carbon dioxide production of the chemical-mechanical energy converter (300).

15. The method (2000) of claim 12, wherein the method (2000) further comprises detecting (2100) an operating condition of the electrical-mechanical energy converter (200) of the motor vehicle (1000) with a sensor (201), by reading out a control unit (202), or both;
wherein transmitting (2200) the detected operating condition of the chemical-mechanical energy converter (300) further comprising transmitting the detected operating condition of the electrical-mechanical energy converter (200) to the location (500) remote from the motor vehicle (1000) with the transmitting device (303); and
wherein evaluating (2300) the operating condition of the chemical-mechanical energy converter (300) further comprising evaluating the operating condition of the electrical-mechanical energy converter (200) at the location (500) remote from the motor vehicle (1000) by comparing the detected operating condition of the electrical-mechanical energy converter (200) with a reference value of the operating condition of the electrical-mechanical energy converter (200) with the at least one processing unit (502).

16. The method (2000) of claim 15, wherein the operating condition of the electrical-mechanical energy converter (200) comprises an energy consumption of the electrical-mechanical energy converter (200).

17. The method (2000) of claim 12, wherein, when the comparison of the detected operating condition of the chemical-mechanical energy converter (300) with the reference value of the operating condition of the chemical-mechanical energy converter (300) yields a deviation that is greater than a predetermined threshold value, the method further comprises:
transmitting (2500) a request to change the operating condition of the chemical-mechanical energy converter (300) to the motor vehicle (1000) from the remote location (500) with the transmitting device (501); and
carrying out (2600) the operating condition change of the chemical-mechanical energy converter (300) in the motor vehicle (1000).

18. The method (2000) of claim 17, further comprising:
transmitting (2500) a request to change the operating condition of the electrical-mechanical energy converter (200) to the motor vehicle (1000) from the remote location (500) with the transmitting device (501); and
carrying out (2600) the operating condition change of the electrical-mechanical energy converter (200) in the motor vehicle (1000).

19. The method (2000) of claim 15, wherein, when the comparison of the detected operating condition of the electrical-mechanical energy converter (200) with the reference value of the operating condition of the electrical-mechanical energy converter (200) yields a deviation that is greater than a predetermined threshold value, the method further comprises:
transmitting (2500) a request to change the operating condition of the electrical-mechanical energy converter (200) to the motor vehicle (1000) from the remote location (500) with the transmitting device (501); and
carrying out (2600) the operating condition change of the electrical-mechanical energy converter (200) in the motor vehicle (1000).

20. The method (2000) of claim 19, further comprising:
transmitting (2500) a request to change the operating condition of the chemical-mechanical energy converter (300) to the motor vehicle (1000) from the remote location (500) with the transmitting device (501); and
carrying out (2600) the operating condition change of the chemical-mechanical energy converter (300) in the motor vehicle (1000).

21. A computer-implemented method for evaluating an operating condition of a motor vehicle (1000) that includes an electrical-mechanical energy converter (200) and a chemical-mechanical energy converter (300), the method comprising:
detecting (2100) an operating condition of the chemical-mechanical energy converter (300) of the motor vehicle;
transmitting (2200) the detected operating condition of the chemical-mechanical energy converter (300) to a location (500) remote from the motor vehicle (1000); and
evaluating (2300) the operating condition of the chemical-mechanical energy converter (300) at the location (500) remote from the motor vehicle (1000) by comparing the detected operating condition of the chemical-mechanical energy converter (300) with a reference value of the operating condition of the chemical-mechanical energy converter (300) in order to determine emissions of a motor vehicle fleet including at least two motor vehicles (1000).

22. A system (3000) for evaluating an operating condition of a motor vehicle (1000) that includes an electrical-mechanical energy converter (200) and a chemical-mechanical energy converter (300), the system (3000) comprising means for:
detecting (2100) an operating condition of the chemical-mechanical energy converter (300) of the motor vehicle (1000) with a sensor (301), by reading out a control unit (302), or both;
transmitting (2200) the detected operating condition of the chemical-mechanical energy converter (300) to a location (500) remote from the motor vehicle (1000) with a transmitting device (303); and
evaluating (2300) the operating condition of the chemical-mechanical energy converter (300) at the location (500) remote from the motor vehicle (1000) by comparing the detected operating condition of the chemical-mechanical energy converter (300) with a reference value of the operating condition of the chemical-mechanical energy converter (300) with at least one processing unit (502) in order to determine emissions of a motor vehicle fleet including at least two motor vehicles (1000).
